(19) United States
(12) Patent Application Publication
(10) Pub. No.: US 2006/0225073 A1
(43) Pub. Date: Oct. 5, 2006

(54) Computer system, log collection method and computer program product

(76) Inventors: Etsutaro Akagawa, Kawasaki (JP); Takahiro Nakano, Yokohama (JP); Tomoya Anzai, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/144,770

(22) Filed: Jun. 6, 2005

(30) Foreign Application Priority Data
Apr. 4, 2005 (JP) 2005-108076

(51) Int. Cl. G06F 9/455

(52) U.S. Cl. 718/1

(57) ABSTRACT

Provided is a computer system in which a plurality of virtual machines operate on a host computer. The host computer has a time subtraction table for storing the time subtraction with the respective virtual machines, and a log collection unit for collecting the logs of the respective virtual machines. The log contains a time stamp which shows at least the log output time. The log collection unit corrects the time stamp of the logs collected from the respective virtual machines based on the time subtraction stored in the time subtraction table. According to this computer system, the logs of the virtual machines operating in a time series that is different from the time series of the host computer can be collected upon integrating the time series of the virtual machines and the host computer.

### CROSS-REFERENCES TO RELATED APPLICATIONS

This application relates to and claims priority from Japanese Patent Application No. 2005-108076, filed on Apr. 4, 2005, the entire disclosure of which is incorporated herein by reference.

### BACKGROUND OF THE INVENTION

1. Field of the Invention

The present invention generally relates to a computer system, a log collection method and a computer program product, and in particular to the log collection technology of a computer system in which a plurality of virtual machines operate on a host computer.

2. Description of the Related Art

In recent years, the technique of storage consolidation which consolidates the storages distributed and disposed for each server, and connects such consolidated storages to a server group via a storage dedicated network such as a SAN (Storage Area Network) or the like is becoming widespread. A storage service provider that provides services relating to the configuration, operation and maintenance of storages, for instance, is providing services of leasing a single storage system to a plurality of customers as an operation mode of storage consolidation. Data centers that provide such storage services are seeking to consolidate storage management and reduce management costs by connecting the logical volumes obtained by logically dividing a large-capacity storage system to the servers of respective clients via the SAN or the like. Further, as a result of equipping an NAS (Network Attached Storage) function to the storage system of data centers, a file system for providing a file access service employing a file transfer protocol such as NFS (Network File System) or CIFS (Common Interface File System) to the respective clients can be created.

Japanese Patent Laid-Open Publication No. 2004-227127 discloses technology of virtually dividing the host OS (Operating System) operating on the computer of the data center to provide the storage service to the respective clients so as to operate a plurality of virtual machines on the same hardware resource, and assigning the respective virtual machines to the servers of the respective clients.

### SUMMARY OF THE INVENTION

The uniform management of hardware is possible by introducing a virtual machine. A virtual machine is capable of the same operations as an ordinary computer. For example, the logs of failures and warnings generated with the virtual machine are stored in the virtual machine. Further, the time of the virtual machine progresses independently from the time of the host computer. Moreover, different networks are respectively used from the perspective of security for the network to be connected to the virtual machine and the network to be connected to the host computer.

In this kind of computer system, it is necessary to collect the logs of the virtual machine for the purpose of auditing whether any manipulation of the computer system or falsification of the data has occurred, or for the purpose of analyzing logs during failures or maintenance. For example, when a network failure occurs due to the network name resolution timeout of the domain name server, since it is not possible to analyze the failure with only logs of the host computer, logs of the virtual machine will become necessary. As a means for collecting logs of the virtual machine, conventionally, a server for collecting logs referred to as a log server was installed on the network, and the time in which the log arrived in the log server was recorded in the log as a time stamp.

Nevertheless, under the network environment where the virtual machine network and the host computer network are different, the virtual machine log and the host computer log cannot be transmitted to the log server via the network. When the two networks are connected, the independence of the network is lost, and security problems will arise.

Further, with a configuration where the logs are stored in the respective virtual machines and the logs of the virtual machines are abstracted from the host computer upon a failure or periodically, since there will be a time subtraction in the time of the host computer and the time of the virtual machines, a time subtraction is contained in the time stamp of the logs abstracted from the virtual machines. When this kind of time subtraction exists in the time stamp of the logs, even if the logs for analyzing failures are collected, such failure analysis will be difficult since the time series of the host computer and the respective virtual machines will not coincide.

In a computer system where a plurality of virtual machines is operating, the uniform management of logs is desired in addition to the uniform management of hardware.

The present invention was devised in view of the foregoing problems, and an object of the present invention is to provide a computer system, a log collection method, and a computer program product capable of abstracting logs in which the time subtraction of the virtual machines and the host computer were corrected.

In order to achieve the foregoing object, the computer system of the present invention is a computer system in which a plurality of virtual machines operate on a host computer; the host computer including: a time subtraction table for storing the time subtraction with the respective virtual machines; and a log collection unit for collecting the log of the respective virtual machines; wherein the log contains a time stanp which shows at least the log output time; and the log collection unit corrects the time stamp of the log collected from the respective virtual machines based on the time subtraction stored in the time subtraction table. According to the foregoing constitution, the logs of virtual machines operating in a time series that is different from the time series of the host computer can be collected upon integrating the time series of the virtual machines and the host computer.

The time subtraction table further stores the subtraction acquisition time showing the time when the time subtraction with the virtual machines was acquired; and the log collection unit may correct the time stamp based on the time subtraction in the subtraction acquisition time that is newer than the time of the time stamp among the subtraction acquisition times stored in the time subtraction table, yet which is the closest to the time of the time stamp. The time subtraction of the host computer and virtual machines is not necessarily fixed, and, for instance, this may fluctuate when the host computer and virtual machines respectively acquire the time information from the NTP server and synchronize the time, or when the time of the virtual machines is falsified by manipulation. As a result of correcting the time stamp based on the time subtraction in the subtraction acquisition time that is newer than the time of the time stamp among the subtraction acquisition times stored in the time subtraction table, yet which is the closest to the time of the time stamp, time stamp correction can be conducted with even higher precision.

The log collection unit may collectively output the logs of the corrected time stamps of the plurality of virtual machines. Thereby, since the logs of the respective virtual machines can be rearranged on the same time axis for analysis, this is preferable for analyzing system failures.

In addition to the time stamp, the log further contains a log message; and the log collection unit may contain a log of the pre-corrected time stamp output time in the log message.

The log collection unit may collect the log from the virtual machines by transmitting a log collection order to the virtual machines. As a result of the host computer abstracting the log via the virtual machines instead of directly abstracting the log from the virtual machines, the security function of the virtual machines can be improved.

The virtual machines may send a time change notification to the host computer each time the time of the virtual machine is changed. Further, the log collection unit may collect the time subtraction with the virtual machines upon receiving the time change notification. As a result, the host computer is able to retain the latest time subtraction with the virtual machines, and time stamp correction can be conducted with even higher precision.

The plurality of virtual machines and the host computer may be respectively connected to different networks. In comparison to the conventional method of collecting logs from a virtual machine via a network using a log server, the present invention is superior in security since there is no need to connect the networks of the virtual machines.

The log collection method of the present invention is a method of collecting logs of a computer system in which a plurality of virtual machines operate on a host computer, including the steps of the host computer acquiring the time subtraction with the virtual machines; the host computer collecting the logs of the virtual machines; and the host computer correcting the time stamp of the logs collected from the virtual machines based on the time subtraction.

The computer program product of the present invention is a product wherein a computer program for making a computer system, in which a plurality of virtual machines operate on a host computer, execute the log collection method is recorded on a recording medium. As the recording medium, for example, preferably employed are optical recording mediums (a recording medium capable of optically reading data such as a CD-RAM, CD-ROM, DVD-RAM, DVD-ROM, DVD-R, PD, MD, MO or the like), magnetic recording mediums (a recording medium capable of magnetically reading data such as a flexible disk, magnetic card, magnetic tape or the like), or a memory element (a semiconductor memory element such as a DRAM, a ferroelectric memory element such as an FRAM, or the like).

According to the present invention, the logs of the virtual machines operating in a time series that is different from the time series of the host computer can be collected upon integrating the time series of the virtual machines and the host computer. Further, even if the time of the virtual machines is wrongfully falsified, the logs of the virtual machines can be collected at a proper time on the host computer. Thereby, the uniform management of virtual machine logs is enabled.

### BRIEF DESCRIPTION OF THE DRAWINGS

FIG. 1 is a schematic diagram of the log collection system according to the present embodiment;

FIG. 2 is a network configuration centered around the computer system according to the present embodiment;

FIG. 3 is a functional configuration of the computer system according to the present embodiment;

FIG. 4 is configuration of the log message;

FIG. 5 is a configuration of the time subtraction table;

FIG. 6 is a configuration of the log table;

FIG. 7 is a management interface to be displayed on the management computer;

FIG. 8 is a processing flow for the host computer to acquire the time subtraction with the virtual machines;

FIG. 9 is a processing flow for the host computer to collect logs from the virtual machines;

FIG. 10 is a processing flow for the host computer to correct the time stamp;

FIG. 11 is a correction example of the log output time contained in the logs of the virtual machines; and

FIG. 12 is a correction example of the log output time contained in the logs of the virtual machines.

### DETAILED DESCRIPTION OF THE PREFERRED EMBODIMENTS

Embodiments of the present invention are now explained with reference to the attached drawings.

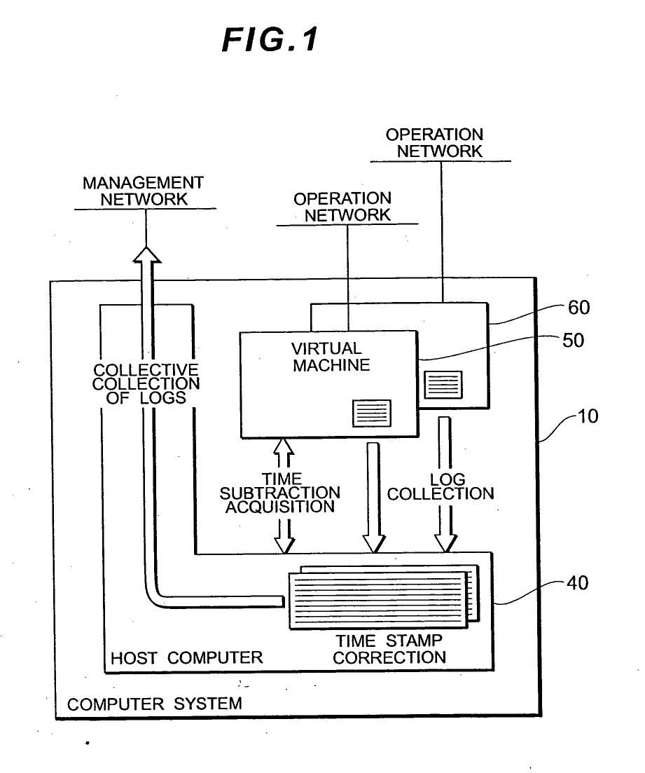

FIG. 1 is a diagram showing the outline of the log collection system according to the present invention. As a result of logically configuring a plurality of virtual machines 50, 60 on a single host computer (actual computer), the computer system 10 is able to operate the guest OS or various application programs on the respective virtual machines 50, 60. The host computer 40 and virtual machines 50, 60 are respectively connected to different networks, and they synchronize their times by acquiring time information from the NTP (Network Time Protocol) on the respective networks. Nevertheless, a time subtraction occurs in the time of the host computer 40 and the time of the virtual machines 50, 60. The time different of the host computer and virtual machines is not necessarily fixed, and, for instance, this may fluctuate when the host computer 40 and virtual machines 50, 60 respectively acquire the time information from the NTP server and synchronize the time, or when the time of the virtual machines 50, 60 is falsified by manipulation.

The host computer 40 (1) acquires in advance the time subtraction of the respective virtual machines 50, 60 and the host computer 40, (2) and, upon collecting the logs from the respective virtual machines 50, 60, (3) corrects the log output time (time stamp) of the respective virtual machines 50, 60 by matching (rearranging on the same time axis) the log output time (time stamp) to the time series of the host computer 40 upon giving consideration to the time subtraction, (4) and collectively outputs the logs of the corrected time subtraction to the management computer (not shown) on the management network 21. According to the log collection system, since the time stamp of the respective virtual machines 50, 60 can be matched to the time series of the host computer 40, the log of the corrected time subtraction can be abstracted. Thus, this is preferable for the audit, failure analysis, maintenance and so on of the computer system 10.

Incidentally, there is no particular limitation to the usage of the computer system 10, and this may be used in general computer systems including an operational environment of a plurality of virtual machines 50, 60. For instance, this may be employed in various computer systems such as workstations, mainframe computers, network servers and personal computers.

### Embodiments

In the present embodiment, an NAS file server for providing a file service via a network is exemplified taking the computer system 10 having an operational environment of operating a plurality of virtual machines on a host computer as the specific example.

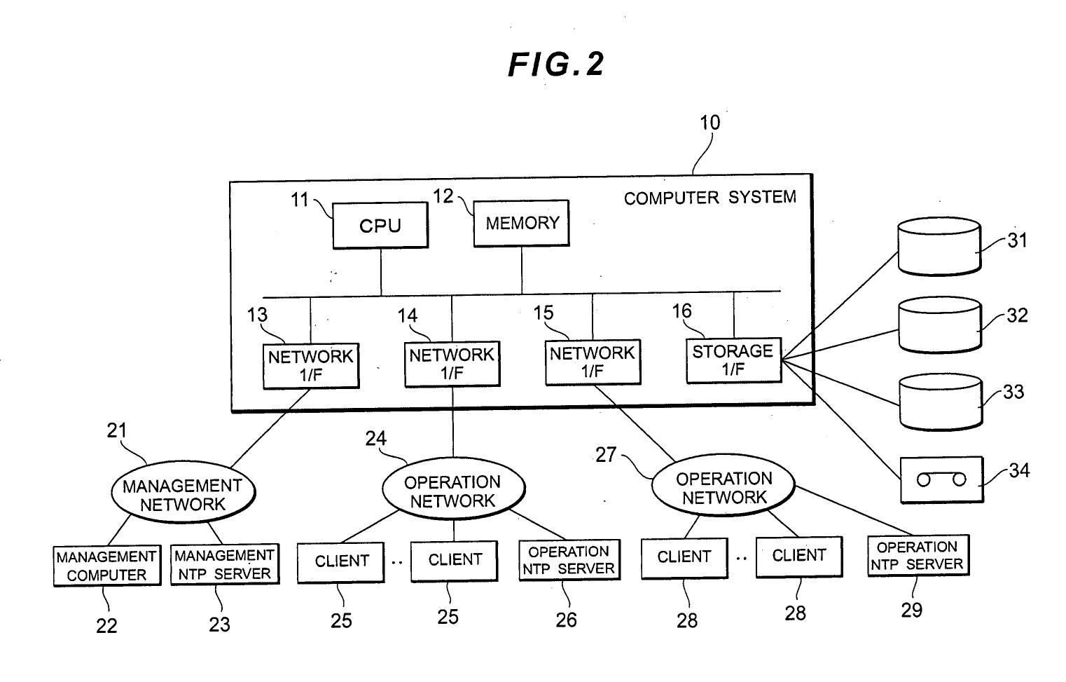

FIG. 2 is a diagram showing the network configuration centered around the computer system 10 within the data center for providing storage services. The computer system 10 includes a CPU 11, a memory 12, network interfaces 13, 14, 15, and a storage interface 16. A management computer 22 and a management NTP server 23 are connected to a network interface 13 via a management network 21. A plurality of client devices 25 and an operation NTP server 26 are connected to a network interface 14 via an operation network 24. A plurality of client devices 28 and an operation NTP server 29 are connected to a network interface 15 via an operation network 27.

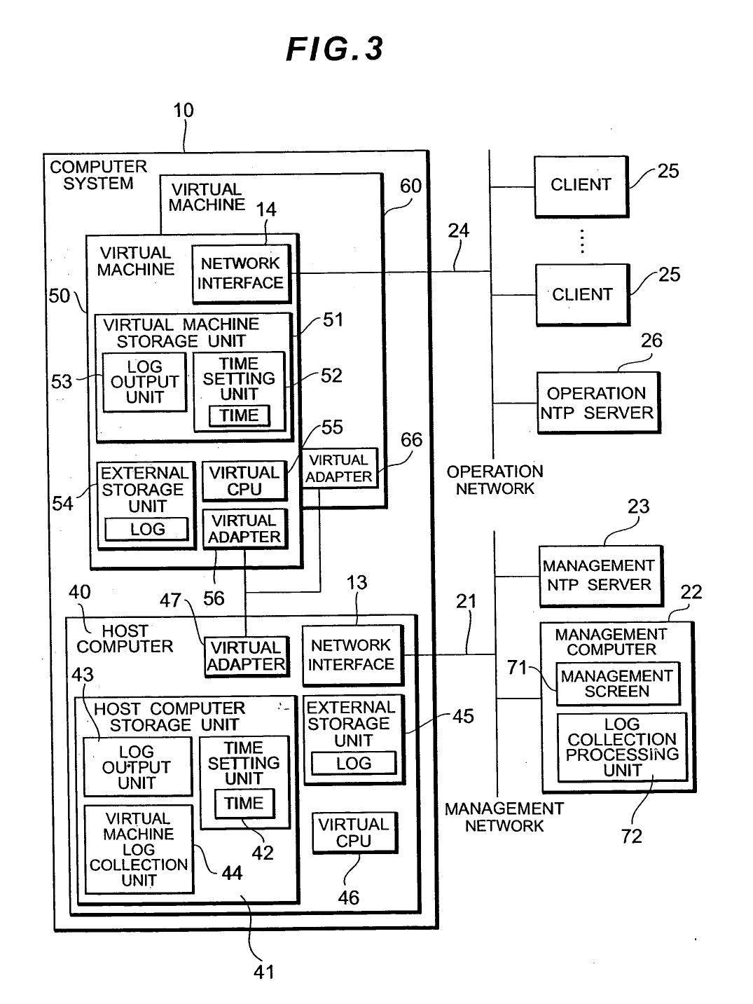

Operating on the computer system 10 are a virtual machine 50 for providing a file service for Company A and a virtual machine 60 for providing a file service for Company B (c.f., FIG. 3). The disk drive 31 stores, for instance, programs and data for the management computer 22 to perform the system audit, failure management and maintenance management of the computer system 10. The disk drives 32, 33, for example, respectively store data for providing file services for Company A and Company B. The tape device 34, for instance, stores backup data of the disk drives 32, 33.

The system administrator is able to access the computer system 10 by making input operations to the management computer 22 so as to conduct the audit, failure management, maintenance management and so on of the computer system 10. Clients of Company A may request data I/O (file access) by designating the file name from the client device 25 to the virtual machine 50 via the operation network 24. Similarly, clients of Company B can request a file access from the client device 28 to the virtual machine 60 via the operation network 27. When the operation networks 24, 27 are, for example, a LAN (Local Area Network), the communication protocol of TCP/IP (Transmission Control Protocol/Internet Protocol) is used for the file access request from the client devices 25, 28 to the virtual machines 50, 60.

Incidentally, as the disk drives 31, 32, 33, a stand-alone hard disk may be used, or a disk array device formed from a plurality of hard disks constituted in a RAID (Redundant Array of Independent Inexpensive Disks) may be employed. Further, a plurality of logical volumes may be formed in the disk drives 32, 33, and data for providing file services to Company A and Company B may be stored in these logical volumes. As the hard disk, for example, a fiber channel disk drive, ATA (Advanced Technology Attachment) disk drive, SCSI (Small Computer System Interface) disk drive and the like may be used.

FIG. 3 is a diagram showing the functional configuration of the computer system 10. Hardware having the same reference numeral as the hardware illustrated in FIG. 2 is the same hardware, and the detailed explanation thereof is omitted. The virtual machine 50 includes a network interface 14, a virtual machine storage unit 51, a time setting unit 52, a log output unit 53, an external storage unit 54, a virtual CPU 55 and a virtual adapter 56.

The virtual machine storage unit 51 is located on the memory 12 assigned to the virtual machine 50. The time setting unit 52 acquires time information from the operation NTP server 26 and sets the time of the virtual machine 50. The time change of the virtual machine 50 is notified to the host computer 40 via the virtual adapter 56. The log output unit 53 creates a log upon receiving the log output order and log contents from the time setting unit 52 or other components, and outputs the log to the external storage unit 54. As the logs to be created by the log output unit 53, for instance, there are various logs such as a log showing that the time of the virtual machine 50 has been changed, a log showing that an application has been installed, a log showing that the password has been changed, a log showing that there is a system failure due to manipulation, a log showing that the system has been shut down due to network failure or other system failures, and so on.

The external storage unit 54 is a storage area functioning as the external storage unit of the virtual machine 50, and the disk drive 32 corresponds thereto in the present embodiment. The virtual CPU 55 is a virtual CPU assigned to the process of the virtual machine 50 based on the time division operation of the CPU 11. The virtual adapter 56 is a virtual adapter that connects the communication between the virtual machine 50 and host computer 40. When the virtual adapter 56 receives the log collection order from the host computer 40, it transmits the log abstracted from the external storage unit 54 to the host computer 40. In the foregoing explanation, the time setting unit 52, log output unit 53 and virtual adapter 56 show the functions to be realized by the virtual CPU 55 executing the processes.

Incidentally, for the sake of convenience of explanation, although only the virtual adapter 66 is shown as the functional configuration of the virtual machine 60, the functional configuration of the virtual machine 60 is the same as the functional configuration of the virtual machine 50.

The host computer 40 includes a network interface 13, a host computer storage unit 41, a time setting unit 42, a log output unit 43, a virtual machine log collection unit 44, an external storage unit 45, a virtual CPU 46 and a virtual adapter 47.

The host computer storage unit 41 is the storage area on the memory 12 assigned to the host computer 40. The time setting unit 42 acquires time information from the management NTP server 23, and sets the time of the host computer 40. The log output unit 43 creates a log upon receiving the log output order and log contents from the time setting unit 42 or other components, and outputs the log to the external storage unit 45. Further, the log output unit 43 is also able to transmit logs of the host computer 40 to the management computer 22 via the management network 21.

The virtual machine log collection unit 44 basically performs the following four processing steps:
(a) Processing of receiving an order to collect logs of the virtual machines 50, 60 from the management computer 22;
(b) Processing of acquiring the time subtraction of the virtual machines 50, 60 and the host computer 40;
(c) Processing of collecting logs of the virtual machines 50, 60 via the virtual adapter 47; and
(d) Processing of correcting the time stamp of the logs of the virtual machines 50, 60 collected with the processing of (c) based on the time subtraction acquired with the processing of (b).

The external storage unit 45 is the storage area that functions as the external storage device of the host computer 40, and the disk drive 31 corresponds thereto in the present example. The virtual CPU 46 is a virtual CPU assigned to the processes of the host computer 40 based on the time subtraction operation of the CPU 11. The virtual adapter 47 is a virtual adapter for connecting the communication between the host computer 40 and the virtual machines 50, 60. In the foregoing explanation, the time setting unit 42, log output unit 43, virtual machine log collection unit 44 and virtual adapter 47 show the functions realized by the virtual CPU 46 executing the processes.

The management computer 22 includes a management screen display unit 71 and a log collection processing unit 72. The management screen display unit 71 is used for providing a user interface between the management computer 22 and system administrator, and, for example, displays a screen for guiding the instructions of the log collection processing to the system administrator, or displaying the logs collected from the computer system 10. The log collection processing unit 72 transmits an order for collecting the logs of the virtual machines 50, 60 to the host computer 40 in response to the instructions of the system administrator.

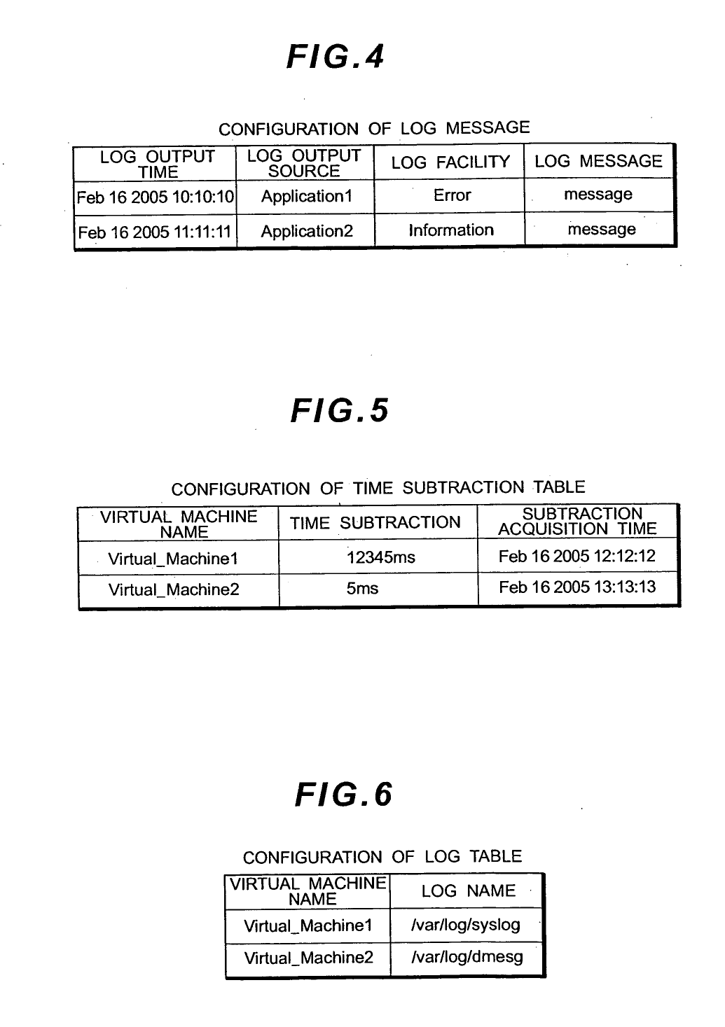

FIG. 4 is a diagram showing the constitution of the log message. In addition to the log output time (time stamp), a log contains an output source, a log facility, a log message and so on as necessary. The log output time shows the time that the log was created at the log generator. The time of the time series of the log generator is recorded as the log output time. In the example illustrated in FIG. 4, an application program operating on the virtual machines 50, 60 is depicted as the log output source. The log facility shows the type of log, and, for instance, Error shows that a failure or manipulation has occurred, and Information shows the other ordinary processing. The log contents are simply displayed in the message in text format. Logs of the host computer 40 and virtual machines 50, 60 all have the message configuration shown in FIG. 4.

FIG. 5 is a diagram showing the configuration of the time subtraction table. When the virtual machine log collection unit 44 receives a notification on time change from the virtual machines 50, 60, it acquires the time of the virtual machines 50, 60, stores the difference (time subtraction) of the time of the host computer 40 and the time of the virtual machines 50, 60 in the time subtraction table, and stores the time in which the time of the virtual machines 50, 60 was acquired (hereinafter collectively referred to as the “subtraction acquisition time”) upon associating it with the time subtraction. In FIG. 5, Virtual_Machine1 represents the virtual machine 50, and Virtual_Machine2 represents the virtual machine 60. In the subsequent explanation, the virtual machine 50 is sometimes referred to as Virtual_Machine1 or VM1, and the virtual machine 60 is sometimes referred to as Virtual_Machine2 or VM2.

FIG. 6 is a diagram showing the table (hereinafter referred to as the “log table”) indicating which log the host computer 40 is to collect among the logs stored in the virtual machines 50, 60. For example, the log of Virtual_Machine1 is stored in a directory of the disk drive 32 designated as /var/log/syslog, and the log of Virtual_Machine2 is stored in the directory of the disk drive 33 designated as /var/log/dmesg. When the virtual machine log collection unit 44 receives a log collection order from the management computer 22, it collects the logs of the virtual machines 50, 60 located in the directory designated in the log table, and corrects the log output time according to the time subtraction table. For example, when the virtual machine log collection unit 44 receives a log collection order from the management computer 22 so as to collect the logs of Virtual_Machine1, it transmits a log collection order to the virtual machine 50 so as to abstract the logs stored in the directory designated in the log table, and transmits this to the virtual machine log collection unit 44.

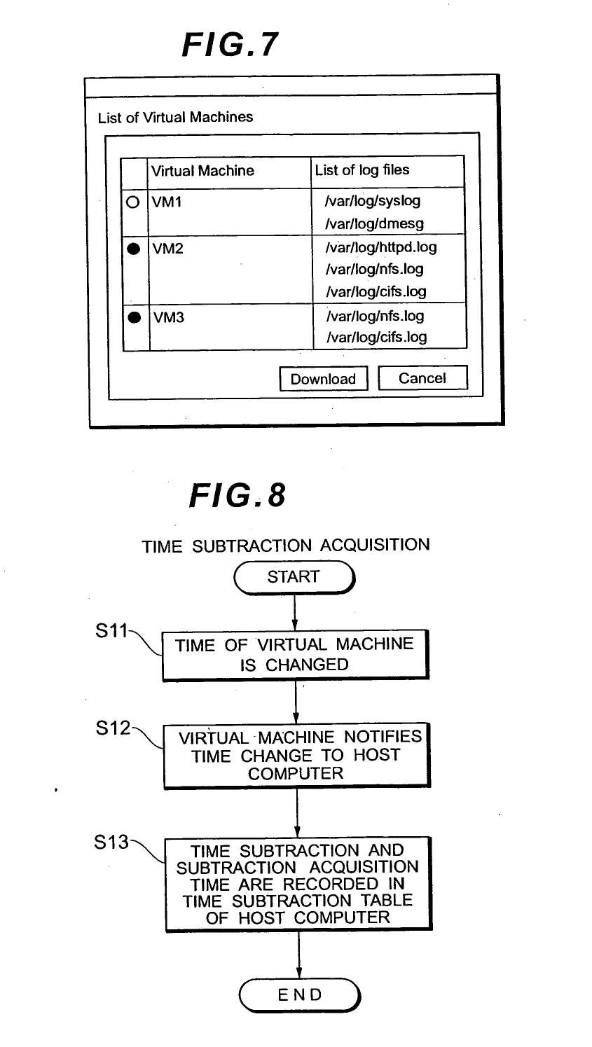

FIG. 7 is a management interface screen to be displayed on the management screen display unit 71 of the management computer 22. The location of the logs of the respective virtual machines is displayed on the management interface screen.

Incidentally, for security reasons, although it is desirable for the host computer 40 to collect the logs via the virtual machines 50, 60 as described above as the means for collecting the logs of the virtual machines 50, 60, the host computer 40 may also be constituted to directly abstract the logs of the virtual machines 50, 60 since it is aware of the storage location of the logs of the virtual machines 50, 60 as a result of retaining the log table (FIG. 6).

FIG. 8 is a flowchart describing the processing steps of the host computer 40 acquiring the time subtraction with the virtual machines 50, 60. As a result of the virtual machines 50, 60 acquiring the time information from the operation NTP servers 26, 29, the time of the virtual machines 50, 60 will change (S11). Then, the virtual machines 50, 60 send a time change notification to the host computer 40 (S12). The host computer 40 acquires the time of the virtual machines 50, 60, and stores the time subtraction and subtraction acquisition time in the time subtraction table (S13). It is preferable that the time subtraction is acquired each time a time change notification is sent from the virtual machines 50, 60, on a steady basis, or in prescribed intervals.

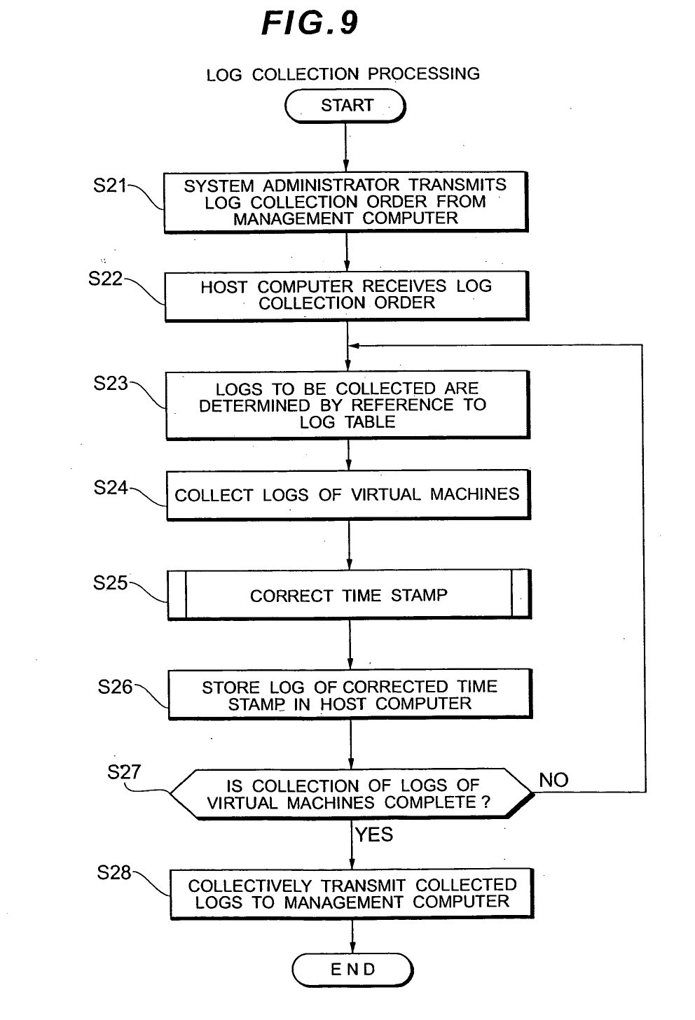

FIG. 9 is a flowchart describing the processing of the host computer 40 collecting logs from the virtual machines 50, 60. Foremost, the system administrator transmits a log collection order from the management computer 22 to the host computer 40 (S21). The timing of collecting the logs of the virtual machines 50, 60 may be periodic, or may be at the time a failure occurs.

When the host computer 40 receives the log collection order from the management computer 22 (S22), it refers to the log table and determines which logs should be collected from the virtual machines 50, 60 (S23). Then, the host computer 40 requests the virtual machines 50, 60 to collect the logs. The virtual machines 50, 60 transmit the logs abstracted from the disk drives 32, 33 to the host computer 40. As a result of taking the foregoing procedures, the host computer 40 is able to collect the logs of the virtual machines 50, 60 (S24).

Next, the host computer 40 uses the time subtraction stored in the time subtraction table and corrects the time stamp of the virtual machines 50, 60 (S25), and stores the log of the corrected time stamp in the host computer 40 (S26). When the host computer 40 has not finished collecting the logs of the virtual machines 50, 60 (S27: NO), it repeats the steps of S23 to S26 once again. Meanwhile, when is has finished collecting the logs of the virtual machines 50, 60 (S27: YES), the host computer 40 transmits the logs collected from the virtual machines 50, 60 to the management computer 22 (S28). The logs collected from the plurality of virtual machines 50, 60, for example, may be rearranged in the time series on the host computer 40 and these logs may be summarized into a single log, and collectively transmitted to the management computer 22.

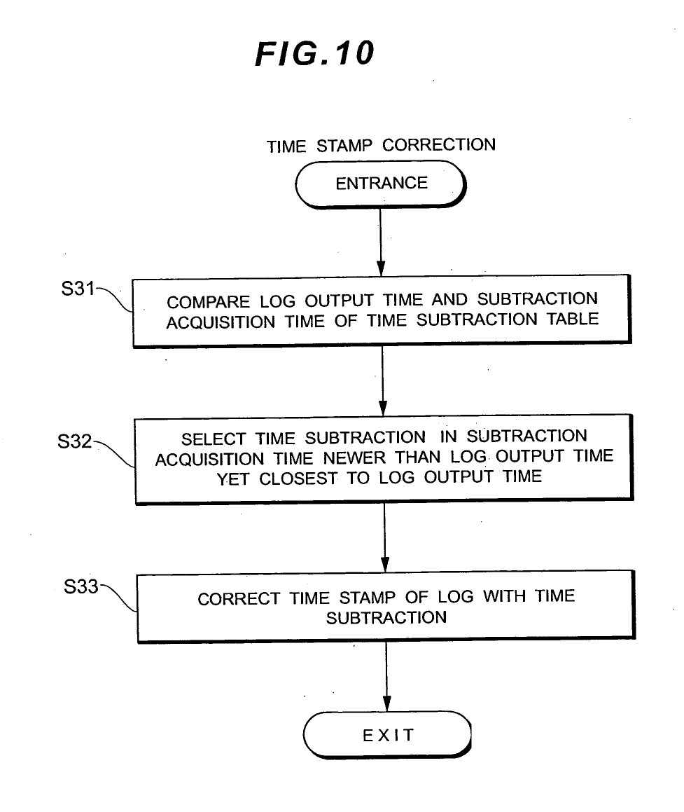

FIG. 10 shows the sub routine for the host computer 40 to correct the time stamp contained in the logs of the virtual machines 50, 60. When this sub routine is called, the host computer 40 compares the log output time contained in the logs collected from the virtual machines 50, 60 and the subtraction acquisition time stored in the time subtraction table (S31), and selects the subtraction acquisition time that is newer than the log output time, yet closest to the log output time (S32). Subsequently, the host computer 40 corrects the log output time based on the time subtraction in the selected subtraction acquisition time (S33).

Incidentally, the time subtraction employed for the correction of the log output time does not necessarily have to be the time subtraction in the latest subtraction acquisition time. It is preferable to correct the log output time based on the time subtraction in the subtraction acquisition time that is newer than the log output time, yet closest to the log output time. Further, the log of the pre-corrected time stamp output time may be included in the log message.

Next, advantages of matching the log output time of the virtual machines 50, 60 to the time series of the host computer 40 are explained.

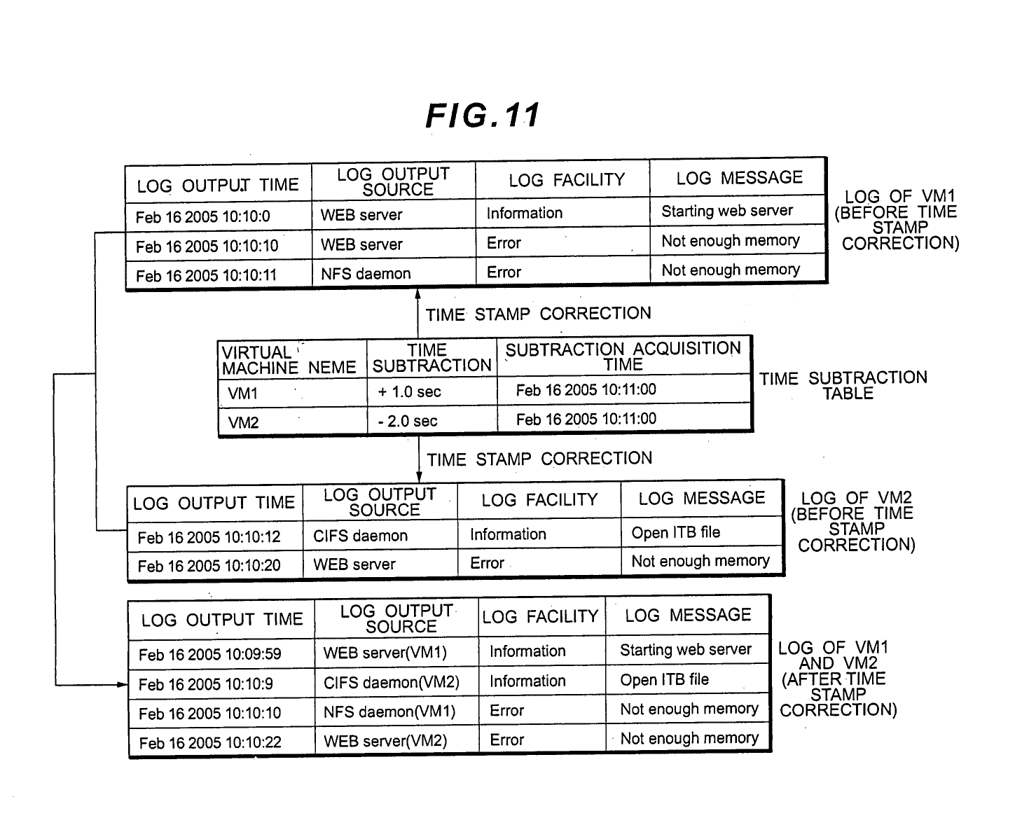

FIG. 11 is a diagram showing an example of rearranging the logs of VM1 and VM2 on the same time axis for the purpose of failure analysis. When comparing the log abstracted from VM1 and the log abstracted from VM2, it is evident that an insufficient memory has occurred at approximately the same time. Under an environment in which a plurality of virtual machines operate on the same hardware resource, a system failure that occurs to one virtual machine may affect the operational environment of the other virtual machine. When a failure occurs to a plurality of virtual machines at approximately the same time, it is difficult to accurately perform a failure analysis merely by analyzing the logs (before the correction of the time stamp) abstracted from the respective virtual machines since a time subtraction is contained in the log output time. Thus, as a result of rearranging the log output times of the logs abstracted from VM1 and VM2 on the same time axis, an accurate failure analysis can be performed. In the example illustrated in FIG. 11, it is evident that, subsequent to an insufficient memory occurring in VM1, an insufficient memory is occurring in VM2. The cause of the insufficient memory of VM2 is due to the insufficient memory of VM1.

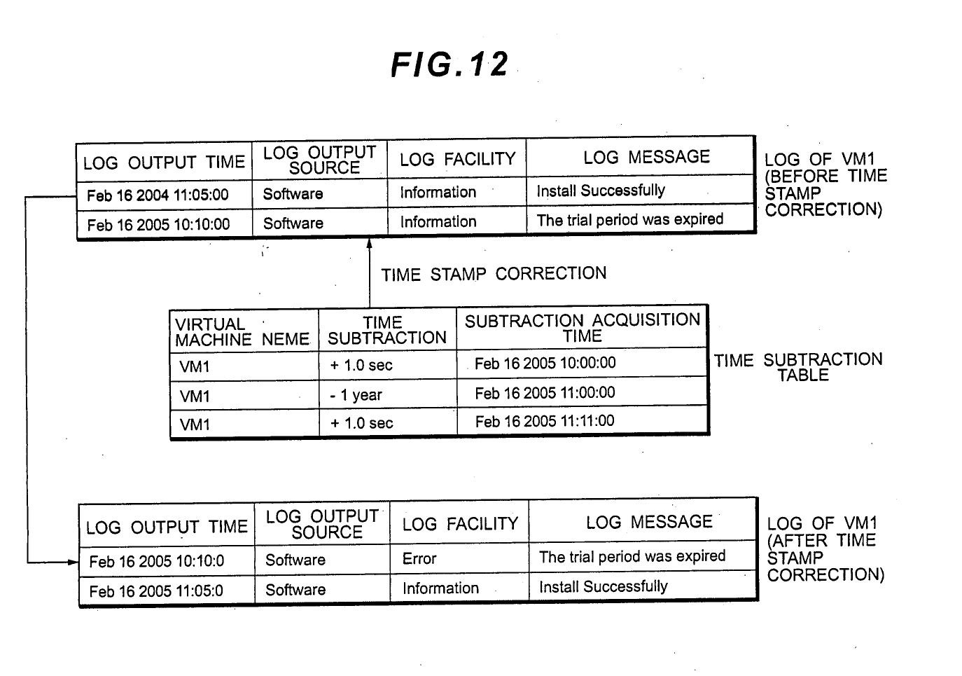

FIG. 12 is a diagram showing an example of rearranging the VM1 logs on the same time axis for the purpose of analyzing manipulations. For instance, let it be assumed that, after the trial period (1 year) of the software operating on VM1 is terminated, the time of VM1 is falsified to a time of one year ago, this software is wrongfully installed in VM1, and thereafter the time of VM1 is returned to the original time. By merely analyzing the logs (before the correction of the time stamp) abstracted from VM1, it will seem like the software has been legitimately installed. Nevertheless, when viewing the time subtraction table, it is evident that the time of VM1, after being returned one year on Feb. 16, 2005, 11:00:00, has been returned to the original time on Feb. 16, 2005, 11:11:00. And, when the log output time of the log abstracted from VM1 is rearranged on the time axis of the host computer 40, it is evident that the trial period of the software expired on Feb. 16, 2005, 10:10:00, and the software was wrongfully installed on Feb. 16, 2005, 11:05:00. Thus, according to the present embodiment, even when the time of the virtual machine 50 is wrongfully falsified, logs of the virtual machine 50 can be collected at the correct time on the host computer 40.

According to the present embodiment, logs of the virtual machines 50, 60 operating in a time series that is different from the time series of the host computer 40 can be integrated to the time series of the host computer 40 and then collectively collected. Further, even if the time of the virtual machines 50, 60 is wrongfully falsified, logs of the virtual machines 50, 60 can be collected at the correct time on the host computer 40. As a result, the uniform management of logs of the virtual machines 50, 60 is enabled. Further, in comparison to the conventional method of collecting logs from a virtual machine via a network using a log server, the present invention is superior in security since there is no need to network-connect the virtual machines. Further, the audit, failure analysis, maintenance and the like of the respective virtual machines 50, 60 on the host computer 40 can be conducted without having to depend on the time subtraction between the host computer 40 and the virtual machines 50, 60. This will also contribute to the reduction of management costs.

Incidentally, in the foregoing explanation, although an example was described where the host computer 40 and the virtual machines 50, 60 operate on the same hardware resource, the present invention may also be employed in cases where the respective hardware operates in a different time series in a system formed by consolidating different hardware, such as in a storage system formed from a disk array device and the maintenance terminal thereof. In the foregoing example, the maintenance terminal does not have to depend on the time series of the disk array device, and the log of the disk array device may be collected upon matching the time series of the maintenance terminals.

The present invention is not limited to the foregoing embodiments. Those skilled in the art may make various additions or modification within the scope of the present invention.

We claim:

1. A computer system in which a plurality of virtual machines operate on a host computer;
the host computer comprising:
a time subtraction table for storing a time subtraction with the respective virtual machines; and
a log collection unit for collecting a log of the respective virtual machines;
wherein the log contains a time stamp which shows at least a log output time, and said log collection unit corrects the time stamp of the log collected from the respective virtual machines based on the time subtraction stored in the time subtraction table.

2. The computer system according to claim 1, said time subtraction table further stores a subtraction acquisition time showing the time when the time subtraction with said virtual machines is acquired, and said log collection unit corrects the time stamp based on the time subtraction in the subtraction acquisition time that is newer than the time of the time stamp among the subtraction acquisition times stored in said time subtraction table, yet which is the closest to the time of the time stamp.

3. The computer system according to claim 1, wherein said log collection unit collectively outputs the logs of the corrected time stamps of the plurality of virtual machines.

4. The computer system according to claim 1, wherein, in addition to the time stamp, the log further contains a log message, and said log collection unit contains the log of a pre-corrected time stamp output time in the log message.

5. The computer system according to claim 1, wherein said log collection unit collects the log from said virtual machines by transmitting a log collection order to said virtual machines.

6. The computer system according to claim 1, wherein said virtual machines send a time change notification to said host computer each time the time of said virtual machines is changed.

7. The computer system according to claim 6, wherein said log collection unit collects the time subtraction with said virtual machines upon receiving said time change notification.

8. The computer system according to claim 1, wherein said plurality of virtual machines and said host computer are respectively connected to different networks.

9. The computer system according to claim 1, wherein said computer system is a NAS file server.

10. A method of collecting a log of a computer system in which a plurality of virtual machines operate on a host computer, comprising the steps of:
acquiring a time subtraction of the respective virtual machines and the host computer;
collecting a log of the virtual machines; and
correcting a time stamp of the log collected from the virtual machines based n the time subtraction.

11. The log collection method according to claim 10, wherein, in the step of collecting the log, said host computer further acquires a subtraction acquisition time showing the time in which the time subtraction with said virtual machines is acquired, and in the step of correcting the time stamp, the time stamp is corrected based on the time subtraction in the subtraction acquisition time that is newer than the time of said time stamp among the subtraction acquisition times stored in said time subtraction table, yet which is the closest to the time of said time stamp.

12. The log correction method according to claim 10, further comprising a step of collectively outputting the logs of the corrected time stamps of said a plurality of virtual machines.

13. The log collection method according to claim 10, further comprising a step of containing the log of a pre-corrected time stamp output time in the log message of said log.

14. The log collection method according to claim 10, further comprising a step of collecting said log from said virtual machines by said host computer transmitting a log collection order to said virtual machines.

15. The log collection method according to claim 10, further comprising a step of said virtual machines sending a time change notification each time the time of said virtual machines is changed.

16. The log collection method according to claim 15, further comprising a step of said host computer acquiring the time subtraction with said virtual machines upon receiving said time change notification from said virtual machines.

17. A computer program product wherein a computer program for making a computer system, in which a plurality of virtual machines operate on a host computer, execute the log collection method according to claim 10 is recorded on a recording medium.
